(19) United States
(12) Patent Application Publication
(10) Pub. No.: US 2025/0348597 A1
(43) Pub. Date: Nov. 13, 2025

(54) METHODS, SYSTEMS, APPARATUSES, AND COMPUTER-READABLE MEDIA FOR DETECTING VULNERABILITIES IN COMPUTER CODE

(71) Applicant: HUAWEI TECHNOLOGIES CO., LTD., Shenzhen (CN)

(72) Inventors: Jiayuan Zhou, Kanata (CA); Xin Guo, Yangzhou (CN); Kui Liu, Hangzhou (CN); Xin Xia, Hangzhou (CN); Yuan Wang, Kanata (CA)

(73) Assignee: HUAWEI TECHNOLOGIES CO., LTD., Shenzhen (CN)

(21) Appl. No.: 19/280,573

(22) Filed: Jul. 25, 2025

Related U.S. Application Data
(63) Continuation of application No. PCT/CN2023/092186, filed on May 5, 2023.

(51) Int. Cl. G06F 21/57

(52) U.S. Cl. CPC G06F 21/577; G06F 2221/033

(57) ABSTRACT

A method, system, apparatus, and computer-readable storage medium for detecting vulnerabilities in computer code. A computer processor calculates a first change between a first version of a section of the computer code and a second version of the section of the computer code, the section of the computer code being similar to a computer-code vulnerability, and the second version is a version prior to the first version. The computer processor determines whether the section of the computer code comprises the computer-code vulnerability based on a similarity between the first change and a second change, the second change being a change between the computer-code vulnerability and a fix for the computer-code vulnerability.

### CROSS-REFERENCE TO RELATED APPLICATION

This application is a continuation application of PCT International Patent Application Ser. No. PCT/CN2023/092186, filed 5 May 2023, the content of which is incorporated herein by reference in its entirety.

### TECHNICAL FIELD

The present disclosure relates generally to methods, systems, apparatuses, and computer-readable storage media for detecting vulnerabilities in computer code, and in particular to methods, systems, apparatuses, and computer-readable storage media for reducing the number of false positives when detecting vulnerabilities in computer code.

### BACKGROUND

In order to develop software projects efficiently, software developers may reuse computer code by copying computer code from one project to another. Significant portions of large software systems may comprise reused computer code from other projects. While computer code reuse may improve the efficiency of developing software, it may also increase the risk of including known vulnerabilities in a software project. Such software reuse may result in vulnerabilities recurring in different software projects. Tools may be used to automatically detect such vulnerabilities resulting from reused computer code so that they may be fixed.

### SUMMARY

Generally according to some embodiments of the disclosure, there are described methods for detecting vulnerabilities in computer code. In order to develop software projects efficiently, software developers may reuse computer code by copying computer code from one project to another. Significant portions of large software systems may comprise reused computer code from other projects. While computer code reuse may improve the efficiency of developing software, it may also increase the risk of including known vulnerabilities in a software project. Such software reuse may result in vulnerabilities recurring in different software projects. Tools may be used to automatically detect such vulnerabilities resulting from reused computer code so that they may be patched or fixed. Clone-based approaches consider the recurring vulnerability detection problem as a code clone detection problem, such as token- or syntax-based detection. Clone-based approaches may search for computer code sections (also referred to as snippets) in target computer code repositories that are similar to known vulnerabilities. The problem with these clone-based approaches is that they have a high false positive rate. Patches or fixes of vulnerabilities often make small changes to the computer code. As a result, a computer code section containing a vulnerability may be similar to a patched computer code section that does not contain the vulnerability. The differences between a vulnerable code section and a patched code section may be minimal and not detectable by a clone-based approach. Clone-based approaches may detect the patched computer code section as a vulnerability resulting in a false positive.

In some embodiments of the disclosure, a method for detecting vulnerabilities in computer code comprises three steps. First, the method may detect a section of computer code in a target computer code repository that is similar to a known vulnerability. Second, the method may calculate a difference (denoted a “diff”) between the section of computer code and the historical versions of the section of computer code (denoted “first changes”). Further, the method may calculate a diff between the known vulnerability and a patch that fixes the vulnerability (denoted a “second change”). Third, the method may compare the second change to each of the first changes. If any of the first changes is similar to the second change, the patch may have been applied to the section of computer code. As such, the method determines that the section of computer code may be a false positive. It may not contain the vulnerability. Alternatively, if none of the first changes is similar to the second change, the section of computer code may not contain the patch. The method determines that the section of computer code may contain the vulnerability.

According to a first aspect of the disclosure, there is described a method for detecting vulnerabilities in computer code. The method comprises calculating a first change between a first version of a section of the computer code and a second version of the section of the computer code, the section of the computer code being similar to a computer-code vulnerability, and the second version is a version prior to the first version. The method further comprises determining whether the section of the computer code comprises the computer-code vulnerability based on a similarity between the first change and a second change, the second change being a change between the computer-code vulnerability and a fix for the computer-code vulnerability.

The method may further comprise calculating the second change between the computer-code vulnerability and the fix for the computer-code vulnerability.

The method may further comprise locating the section of the computer code that is similar to the computer-code vulnerability. Locating the section of the computer code that is similar to the computer-code vulnerability may comprise using code clone detection. The code clone detection may use artificial intelligence.

The method may further comprise determining the similarity of the first change and the second change using code clone detection.

The method may further comprise calculating a plurality of changes between the first version of the section of the computer code and a plurality of other versions of the section of the computer code, wherein the plurality of other versions are versions prior to the first version. Determining whether the section of the computer code comprises the computer-code vulnerability may be based on the similarity of the second change and any one of the plurality of changes.

Determining whether the section of the computer code comprises the computer-code vulnerability may comprise determining that the section of the computer code does not comprise the computer-code vulnerability when the first change is similar to the second change. Determining whether the section of the computer code comprises the computer-code vulnerability may comprise determining that the section of the computer code comprises the computer-code vulnerability when the first change is not similar to the second change.

The method may further comprise receiving the computer-code vulnerability from a security advisory service.

The method may further comprise displaying the section of the computer code when the section of the computer code comprises the computer-code vulnerability.

According to a further aspect of the disclosure, there is provided a non-transitory computer-readable medium comprising computer instructions stored thereon for detecting vulnerabilities in computer code, wherein the computer instructions, when executed by one or more processors, causes the one or more processors to perform a method comprising: calculating a first change between a first version of a section of the computer code and a second version of the section of the computer code, the section of the computer code being similar to a computer-code vulnerability, and the second version is a version prior to the first version; and determining whether the section of the computer code comprises the computer-code vulnerability based on a similarity between the first change and a second change, the second change being a change between the computer-code vulnerability and a fix for the computer-code vulnerability.

The method may further comprise performing any of the operations described above in connection with the first aspect of the disclosure.

According to a further aspect of the disclosure, there is provided a computing device comprising one or more processors operable to perform a method for detecting vulnerabilities in computer code, wherein the method comprises: calculating a first change between a first version of a section of the computer code and a second version of the section of the computer code, the section of the computer code being similar to a computer-code vulnerability, and the second version is a version prior to the first version; and determining whether the section of the computer code comprises the computer-code vulnerability based on a similarity between the first change and a second change, the second change being a change between the computer-code vulnerability and a fix for the computer-code vulnerability.

The method may further comprise performing any of the operations described above in connection with the first aspect of the disclosure.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

For a more complete understanding of the disclosure, reference is made to the following description and accompanying drawings, in which:

FIG. 1 is a schematic diagram of a computer network system for detecting vulnerabilities in computer code, according to some embodiments of this disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a schematic diagram of a computer code commit;

FIG. 5 is a schematic diagram of a patch for a vulnerability;

FIG. 6 is a flow diagram of a method performed by the computer network system shown in FIG. 1 for detecting vulnerabilities in computer code, according to some embodiments of this disclosure;

FIG. 7 is a schematic diagram of a system for detecting vulnerabilities in computer code, according to some embodiments of this disclosure;

FIG. 8 is a schematic diagram of a system for detecting vulnerabilities in computer code, according to some embodiments of this disclosure;

FIG. 9 is a schematic diagram of a system for detecting vulnerabilities in computer code, according to some embodiments of this disclosure;

FIG. 10 is a schematic diagram of a system for detecting vulnerabilities in computer code, according to some embodiments of this disclosure; and

FIG. 11 is an example of the detection of a false positive, according to some embodiments of this disclosure.

### DETAILED DESCRIPTION

Embodiments disclosed herein relate to a vulnerability detection module or circuitry for executing a vulnerability detection process.

As will be described later in more detail, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As will be described in more detail below, the vulnerability detection module may be a part of a device, an apparatus, a system, and/or the like, wherein the vulnerability detection module may be coupled to or integrated with other parts of the device, apparatus, or system such that the combination thereof forms the device, apparatus, or system. Alternatively, the vulnerability detection module may be implemented as a standalone device or apparatus.

The vulnerability detection module executes a vulnerability detection process for detecting vulnerabilities in computer code. Herein, a process has a general meaning equivalent to that of a method, and does not necessarily correspond to the concept of computing process (which is the instance of a computer program being executed). More specifically, a process herein is a defined method implemented using hardware components for processing data (for example, computer code, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the vulnerability detection process disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. The vulnerability detection module may read the computer-executable code from the storage devices and execute the computer-executable code to perform the processes.

Alternatively, the vulnerability detection process disclosed herein may be implemented as one or more hardware structures having necessary electrical and/or optical components, circuits, logic gates, integrated circuit (IC) chips, and/or the like.

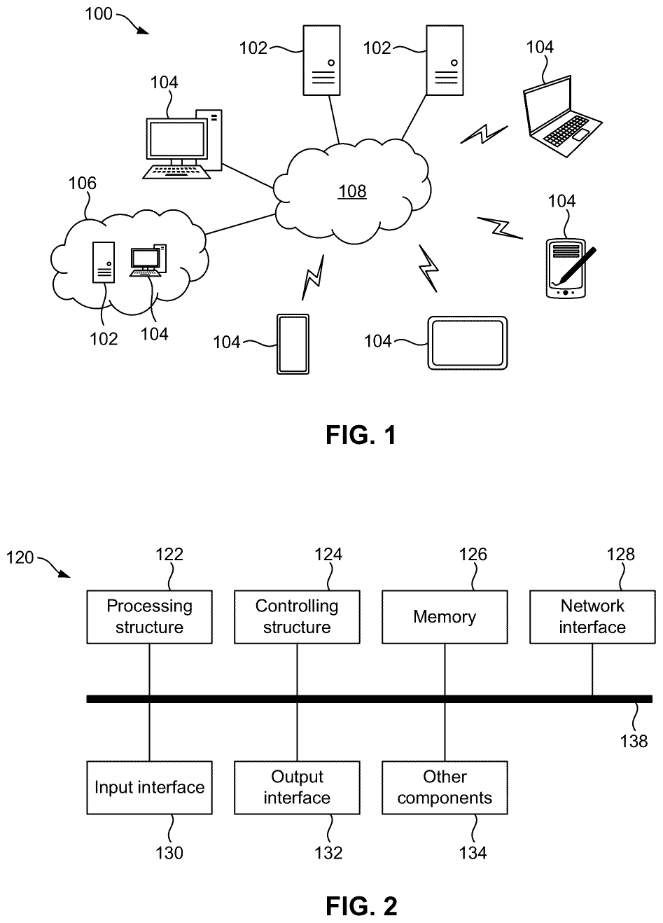

Turning now to FIG. 1, a computer network system for detecting vulnerabilities in computer code is shown and is generally identified using reference numeral 100. In these embodiments, the vulnerability detection system 100 is configured for detecting vulnerabilities in computer code.

As shown in FIG. 1, the vulnerability detection system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections. The client computer systems 106 may have a similar structure as the vulnerability detection system 100.

The server computers 102 may be computing devices designed specifically for use as a server, and/or general-purpose computing devices acting as server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure 120 shown in FIG. 2. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus 138.

The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case may be. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software. Of course, those skilled the art will appreciate that a process or a function (and thus the processor 122) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

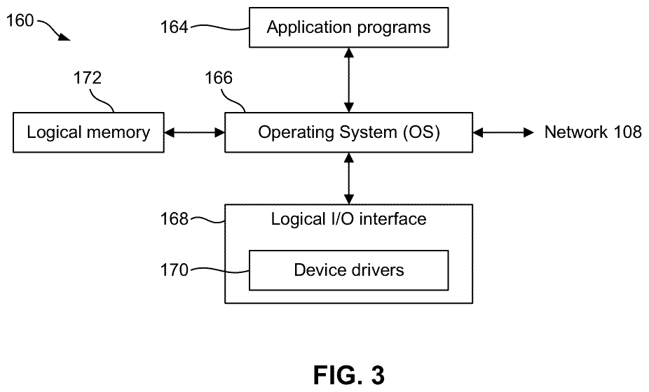

FIG. 3 shows a simplified software architecture 160 of the computing device 102 or 104. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like.

The computing devices 102 and 104 of the vulnerability detection system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the vulnerability detection system 100 may have the potential to perform various tasks, it cannot perform any tasks and is of no use without meaningful firmware and/or software. As will be described in more detail later, the vulnerability detection system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

The following embodiments may all be implemented on an electronic device (for example, vulnerability detection system 100) with the foregoing hardware structure.

In order to develop software projects efficiently, software developers may reuse computer code by copying computer code from one project to another. Significant portions of large software systems may comprise reused computer code from other projects. While computer code reuse may improve the efficiency of developing software, it may also increase the risk of including known vulnerabilities in a software project. Such software reuse may result in vulnerabilities recurring in different software projects. Tools may be used to automatically detect such vulnerabilities resulting from reused computer code so that they may be patched or fixed. Clone-based approaches consider the recurring vulnerability detection problem as a code clone detection problem, such as token- or syntax-based detection. Clone-based approaches may search for computer code sections (also referred to as snippets) in a target computer code repository that are similar to known vulnerabilities. The problem with these clone-based approaches is that they have a high false positive rate. Patches or fixes of vulnerabilities often make small changes to the computer code. As a result, a computer code section containing a vulnerability may be similar to a patched computer code section that does not contain the vulnerability. The differences between a vulnerable code section and a patched code section may be minimal and not detectable by a clone-based approach. Clone-based approaches may detect the patched code section as a vulnerability resulting in false positives.

One example of such clone-based approaches is SourcererCC. As already noted, these approaches have a high false positive rate because they cannot distinguish between vulnerable code sections and patched code sections. These approaches also fail to detect vulnerabilities whose vulnerable code sections have syntactic differences from those of the known vulnerabilities but have the same semantic meaning.

Another approach uses artificial intelligence (AI) to detect vulnerabilities in computer code. One example of such an AI based approach is VulDeePecker. Similar to clone-based approaches, AI based approaches have a high false positive rate because they cannot detect the differences between vulnerable code and patched code. Another problem with these AI based approaches is that they are not programming language agnostic. AI systems trained to detect vulnerabilities will only work with a specific programming language. Each programming language may require its own AI system specifically developed to detect vulnerabilities in that language.

Yet another approach uses function matching. One example of this approach is disclosed in Xiao, Yang, et al. “MVP: Detecting Vulnerabilities using Patch-Enhanced Vulnerability Signatures” USENIX Security Symposium 2020. Such function matching based approaches use an external tool (such as Joern) to generate a signature for the computer code. The signatures may be used to identify computer code sections that are similar to known vulnerabilities. These external tools are unreliable. The method is complex and not generalizable due to delicate and complex signature design. The method is not programming language agnostic. Each programming language may require its own system.

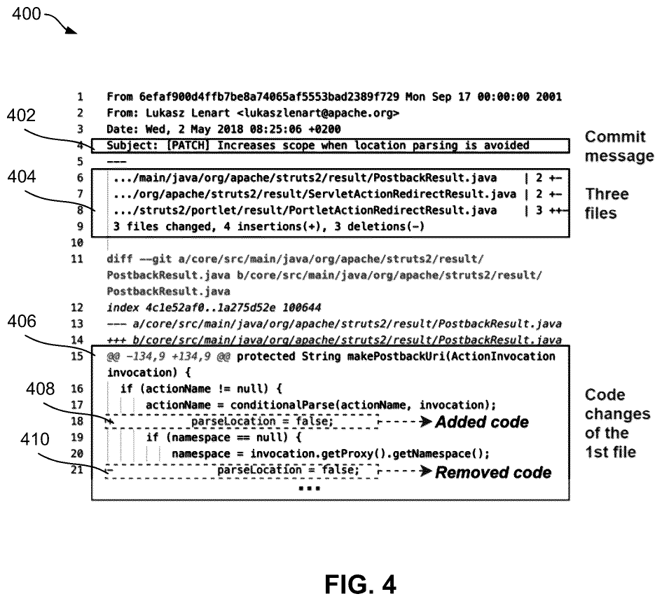

FIG. 4 shows a commit 400 of computer code to a computer code repository. A commit comprises a commit message 402 describing the nature of the change to the computer code, the file names 404 of the files that have been modified, and the changes to the computer code 406. The changes to the computer code 406 show both the added code 408 and the removed code 410. The information contained in a computer code commit 400 in a target repository of computer code may be used to assist in detecting computer code vulnerabilities resulting from the reuse of computer code.

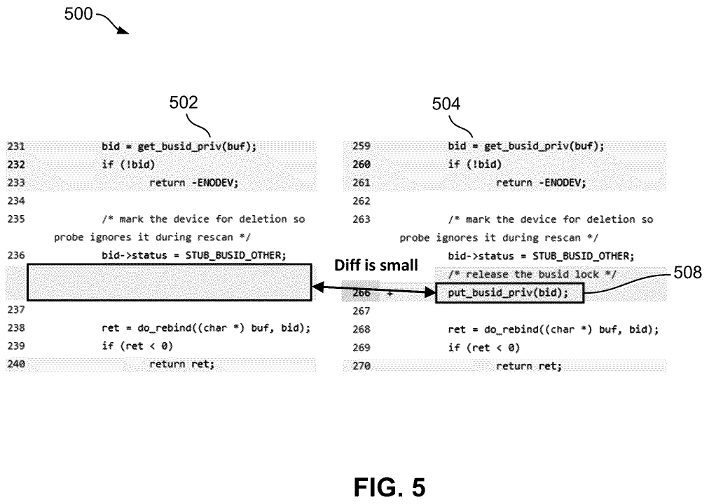

FIG. 5 shows a patch for a vulnerability 500. The first computer code section 502 contains a vulnerability, while the second computer code section 504 has been patched. The fix for the vulnerability is a single line of code 508. The only difference between the vulnerable code section 502 and the patched code section 504 is the line of code 508. The code section 502 and the code section 504 are over 96% similar. As a result, traditional methods for detecting vulnerabilities would likely detect the patched code section 504 as containing the vulnerability even though the vulnerability in code section 504 has been fixed.

That is, with traditional methods for detecting vulnerabilities, code section 504 would likely result in a false positive.

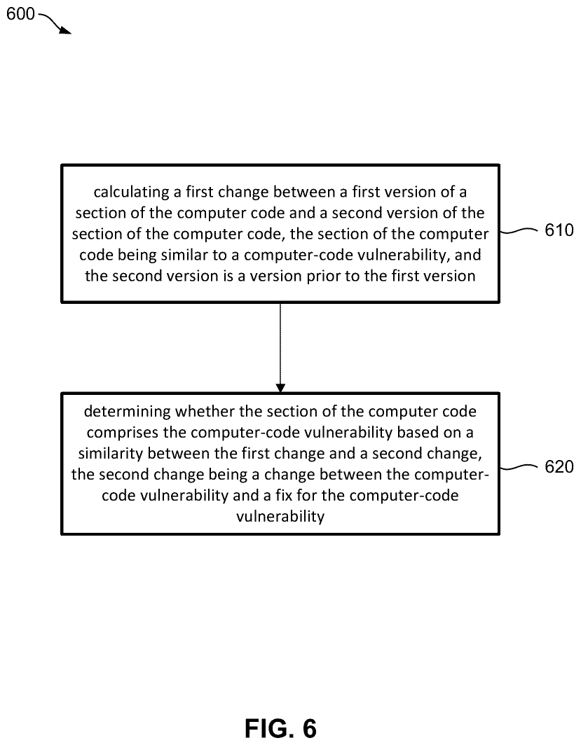

FIG. 6 shows an exemplary method 600 for detecting vulnerabilities in computer code. Computer code may also be referred to as source code. The method 600 may be performed, for example, by the vulnerability detection system 100. The method 600 comprises calculating a first change between a first version of a section of the computer code and a second version of the section of the computer code, the section of the computer code being similar to a computer-code vulnerability, and the second version is a version prior to the first version (step 610). The section of computer code may be a section of computer code from a target computer code repository. The section of computer code may be similar to a known vulnerability. The section of computer code may be considered to be similar to the vulnerability if a similarity comparison or measurement between the section of computer code and the vulnerability obtained using a suitable code clone detection method is smaller than a predefined threshold. For example, a code clone detection method may use a text duplication detection method to calculate a similarity score. The section of computer code and the vulnerability are considered similar if the calculated similarity score is smaller than a predefined threshold. The section of computer code potentially contains the vulnerability. The section of computer code may be compared to at least one of its historical versions. A list of changes, sometimes referred to as a diff, is generated between the current version of the section of computer code and the historical version. The section of computer code may be compared to all of its historical versions or a subset of its historical versions. The historical versions of computer code may be stored and retrieved from the target computer code repository, such as Git.

The following terminology may be used throughout the present disclosure. Symbol A may refer to a known vulnerability, and symbol a may refer to a section of computer code in the target computer code repository that is similar to the vulnerability. Diff-A_{vul,patch} may refer to the diff (that is, the changes) between the vulnerability and its patch. aᵥ may refer to the current version of the section of computer code, and aᵥ₋ₓ may refer to the x^{th} historical version of the section of computer code. Diff-a_{v-x,v} may refer to the diff between the current version of the section of computer code and a historical version of the section of computer code. The method 600 may calculate the diff between the current version of the computer code and each historical version aᵥ₋₁, aᵥ₋₂, . . . , aᵥ₋ₓ (or a subset thereof) resulting in diff-a_{v-1,v}, diff-a_{v-2,v}, . . . , diff-a_{v-x,v}, one diff per historical version.

The method 600 further comprises determining whether the section of the computer code comprises the computer-code vulnerability based on a similarity between the first change (for example, diff-a_{v-x,v}) and a second change (for example, diff-A_{vul,patch}), the second change being a change between the computer-code vulnerability and a fix for the computer-code vulnerability (step 620). The first change may be considered to be similar to the second change if a similarity comparison or measurement between the first and second changes obtained using a suitable code clone detection method is smaller than a predefined threshold. For example, a code clone detection method may use a text duplication detection method to calculate a similarity score. The first and second changes are considered similar if the calculated similarity score is smaller than a predefined threshold. The objective is to reduce the number of false positives by filtering out the sections of computer code that have already been fixed. At least one of the first changes diff-a_{v-x,v} is compared to diff-A_{vul,patch}. All of the first changes diff-a_{v-x,v}, or a subset thereof, may be compared to diff-A_{vul,patch}. If one of the first changes diff-a_{v-x,v} is similar to diff-A_{vul,patch}, then the current version of the section of computer code aᵥ contains the patch and the historical version aᵥ₋ₓ contains the vulnerability. The method 600 may have detected a false positive, as the current version of the section of computer code may not contain the vulnerability. The vulnerability may have already been fixed. As such, this section of computer code may be filtered out and not reported as potentially containing the vulnerability. Alternatively, if none of the first changes diff-a_{v-x,v} is similar to the second change diff-A_{vul,patch}, then the current version of the section of computer may not contain the patch. The current version may not already have been fixed and may not be a false positive. The current version of the section of computer code may contain the vulnerability and may be reported as a potential vulnerability. The method 600 detects false positives by searching through the historical versions of a section of computer code that has been identified as potentially a vulnerability to determine if the patch for the vulnerability has been applied to the section of computer code. If the diff between the current version of the section of computer code and a historical version of the computer code is similar to the diff between the vulnerability and its patch, then the section of computer code may contain the patch. The diff between the vulnerability and the patch represents the change required to fix the vulnerability. If the same change may be found in the historical versions of the section of computer code, then the section of computer code has been fixed. This enables the method 600 to distinguish between vulnerable code snippets and patched code snippets, even though they are similar, and thus to reduce the number of false positives.

The method 600 may further comprise locating the section of the computer code that is similar to the computer-code vulnerability. For a given vulnerability, the method 600 may comprise detecting sections of computer code in a target computer code repository that are similar to the known vulnerability. This may be repeated for a plurality of known vulnerabilities. Any suitable method may be used to identify the sections of computer code that are similar to the known vulnerabilities. For example, locating the section of the computer code that is similar to the computer-code vulnerability may comprise using code clone detection. The code clone detection may use artificial intelligence. That is, clone-based approaches (such as SourcererCC), AI based approaches (such as VulDeePecker), function matching based approaches (such as MVP), or any other suitable approaches may be used to detect vulnerabilities in the target computer code.

The method 600 may further comprise calculating the second change between the computer-code vulnerability and the fix or patch for the computer-code vulnerability (that is, diff-A_{vul,patch}). The second change may be calculated once for each vulnerability and stored for reuse. Alternatively, the second change may be calculated for each section of target computer code that is similar to the vulnerability. Alternatively, the method 600 may retrieve the second change from a vulnerabilities database along with the vulnerability and the patch, or from another database.

The method 600 may further comprise determining the similarity of the first change (that is, diff-a_{v-x,v}) and the second change (that is, diff-A_{vul,patch}) using code clone detection. Known methods for determining the similarity of computer code, such as clone-based approaches (such as SourcererCC), AI based approaches (such as VulDeePecker), function matching based approaches (such as MVP), or any other suitable methods may be used to determine whether the first change is similar to the second change.

The method 600 may further comprise calculating a plurality of changes (diff-a_{v-1,v}, diff-a_{v-2,v}, . . . , diff-a_{v-x,v}) between the first version (that is, current version aᵥ) of the section of the computer code and a plurality of other versions (that is, historical versions aᵥ₋₁, aᵥ₋₂, . . . , aᵥ-x) of the section of the computer code, wherein the plurality of other versions are versions prior to the first version. The first or current version of the section of computer code that is similar to the vulnerability may be compared to a single historical version of the section of computer, a subset of the historical versions of the section of computer code, or all of the historical versions of the section of computer code. For each historical version, a diff of the changes between the current version and the historical version may be generated (diff-a_{v-1,v}, diff-a_{v-2,v}, . . . , diff-a_{v-x,v}). Determining whether the section of the computer code comprises the computer-code vulnerability may be based on the similarity of the second change and any one of the plurality of changes. If the second change (diff-A_{vul,patch}) is similar to at least one of the plurality of changes (diff-a_{v-1,v}, diff-a_{v-2,v}, . . . , diff-a_{v-x,v}), then the patch has been applied to the target computer code, and the method 600 may infer that this may be an instance of a false positive.

Determining whether the section of the computer code comprises the computer-code vulnerability comprises determining that the section of the computer code does not comprise the computer-code vulnerability when the first change (diff-a_{v-x,v}) is similar to the second change (diff-A_{vul,patch}). If the first change, or any one of the plurality of changes (diff-a_{v-1,v}, diff-a_{v-2,v}, . . . , diff-a_{v-x,v}), is similar to the second change, then the first change may represent the patch. That is the current version of the computer code may contain the patch. The similarity between the target computer code and the vulnerability may be a false positive. The method 600 may determine that the target computer code does not contain the vulnerability.

Determining whether the section of the computer code comprises the computer-code vulnerability comprises determining that the section of the computer code comprises the computer-code vulnerability when the first change is not similar to the second change. If the first change, or all of the plurality of changes (diff-a_{v-1,v}, diff-a_{v-2,v}, . . . , diff-a_{v-x,v}), are not similar to the second change, then the target computer code may not have been patched. The method 600 may determine that the target computer code does contain the vulnerability.

The method 600 may further comprise receiving the computer-code vulnerability from a security advisory service. The method 600 may receive one or more vulnerabilities and patches from a security advisory service or other database of vulnerabilities. For example, the method 600 may retrieve the one or more vulnerabilities from a remote server 102 via the network 108.

The method 600 may further comprise displaying the section of the computer code when the section of the computer code comprises the computer-code vulnerability. If the target computer code contains the vulnerability, the method 600 may comprise reporting this vulnerability to a user.

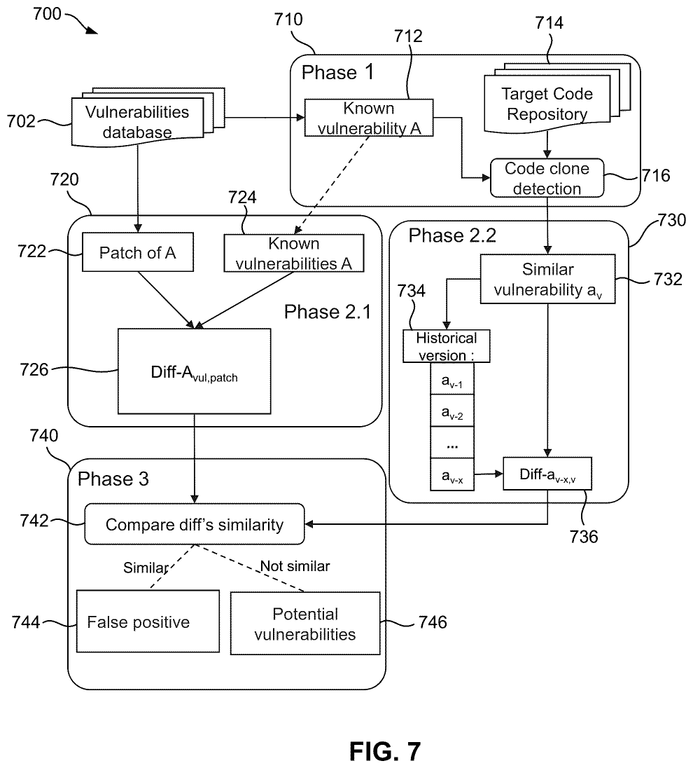

FIG. 7 shows a system for detecting vulnerabilities in computer code 700. The system comprises a vulnerabilities database 702, which may be a security advisory service. The vulnerabilities database 702 may store the known vulnerabilities and the patches for those vulnerabilities. The vulnerabilities database 702 may also store the diffs between vulnerabilities and their patches. The system 700 may obtain the vulnerabilities and the patches form the vulnerabilities database 702 via the network 108. The input to the system 700 may comprise known vulnerabilities from the vulnerabilities database 702 and target computer code from a repository 714. The system 700 may process the input in three phrases. In a first phase 710, the system 700 may detect sections of computer code in the target code repository 714 that are similar to one or more vulnerabilities. In a first part of a second phase 720, the diff between the vulnerability and its patch (diff-A_{vul,patch}) may be calculated. In a second part of the second phase 730, the diff between the current version of the target section of computer code and each of its historical versions (diff-a_{v-1,v}, diff-a_{v-2,v}, . . . , diff-a_{v-x,v}) may be calculated. In a third phase 740, a determination may be made as to whether the target section of computer code contains the vulnerability.

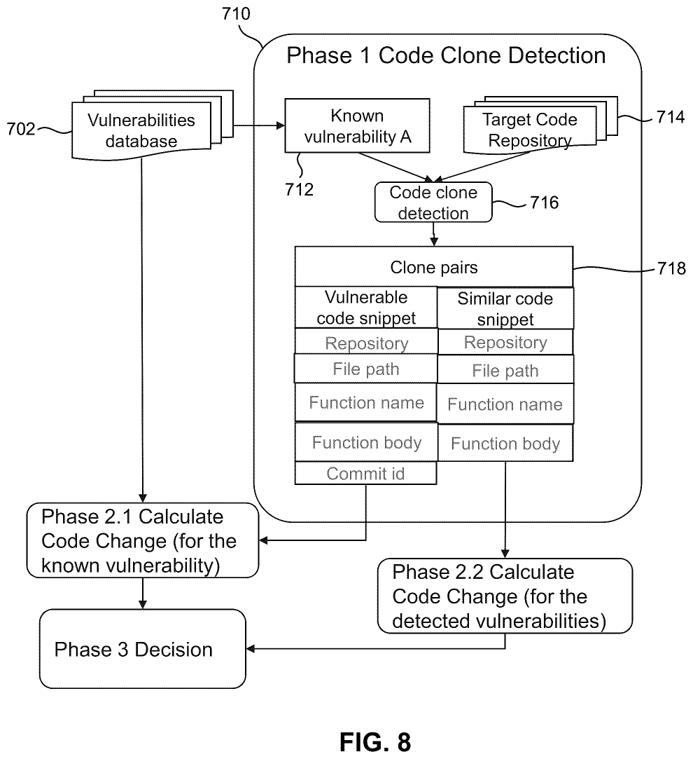

FIG. 8 shows the first phase 710. In the first phase 710, the system may retrieve vulnerable code sections 712 from the vulnerabilities database 702. The system 700 may search the target code repository 714 for sections of computer code that are similar to the known vulnerabilities 712. The search may be conducted using any suitable code clone detection method 716, such as hash-based, locality-sensitive hash-based, SourcererCC, or artificial-intelligence-based code clone detection technology. Any detected similar sections of computer code are potential vulnerabilities. The output of the first phase 710 may comprise a clone pairs 718. A clone pair may comprise the vulnerable computer code, the similar section of computer code, and other related information, such as the repository, file path, function name, function body, and commit id of the computer code sections.

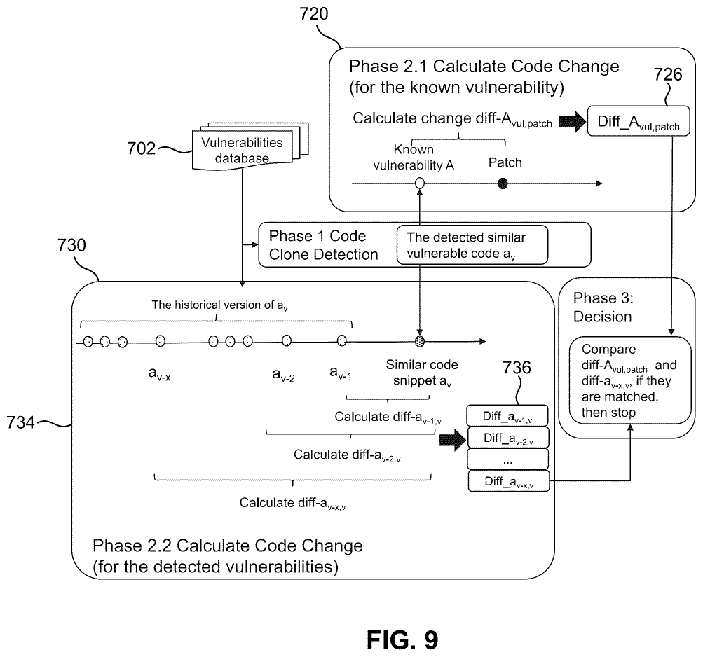

FIG. 9 shows the second phase 720/730. In the first part of the second phase 720, the diff may be calculated between the vulnerability and its patch (diff-A_{vul,patch}) 726. In the second part of the second phase 730, the diff may be calculated between the similar section of computer code and each of its historical versions. For each section of computer code that is similar to the vulnerability aᵥ, the system 700 may retrieve the historical versions 734 of the section of computer code: aᵥ₋₁, aᵥ₋₂, . . . , aᵥ₋ₓ from the target code repository 714. The system 700 may calculate the diff between the current version of the computer code and each historical version (or a subset thereof) resulting in diff-a_{v-1,v}, diff-a_{v-2,v}, . . . , diff-a_{v-x,v} 736, a diff corresponding to each historical version. The historical versions may be arranged in a timeline from oldest to newest. The diffs may be calculated starting with the most recent historical version. The system 700 may be optimized by stopping the calculation of the diffs when a first diff-a_{v-x,v} 736 is found that is similar to diff-A_{vul,patch} 726.

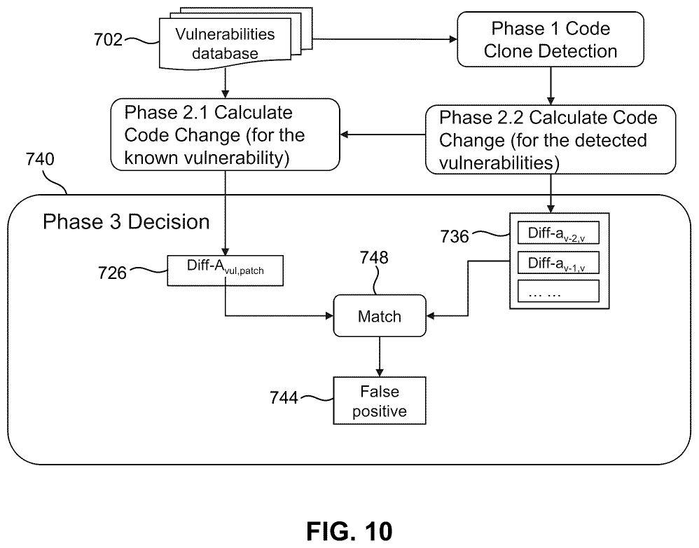

FIG. 10 shows the third phase 740. In the third phase 740, the diffs may be compared to determine whether the target section of computer code contains the vulnerability. Diff-A_{vul,patch} 726 may be compared to each one of diff-a_{v-1,v}, diff-a_{v-2,v}, . . . , diff-a_{v-x,v} 736, or a subset thereof. If diff-A_{vul,patch} 726 is similar 748 to any one of diff-a_{v-1,v}, diff-a_{v-2,v}, . . . , diff-a_{v-x,v} 736, then the patch may have been applied to the target section of computer code. The detection of the target section of computer code may be a false positive 744. Alternatively, if diff-A_{vul,patch} 726 is not similar to any one of diff-a_{v-1,v}, diff-a_{v-2,v}, . . . , diff-a_{v-x,v} 736, then the patch may not have been applied to the target section of computer code. The target section of computer code potentially contains the vulnerability, and it may be reported as a potential vulnerability.

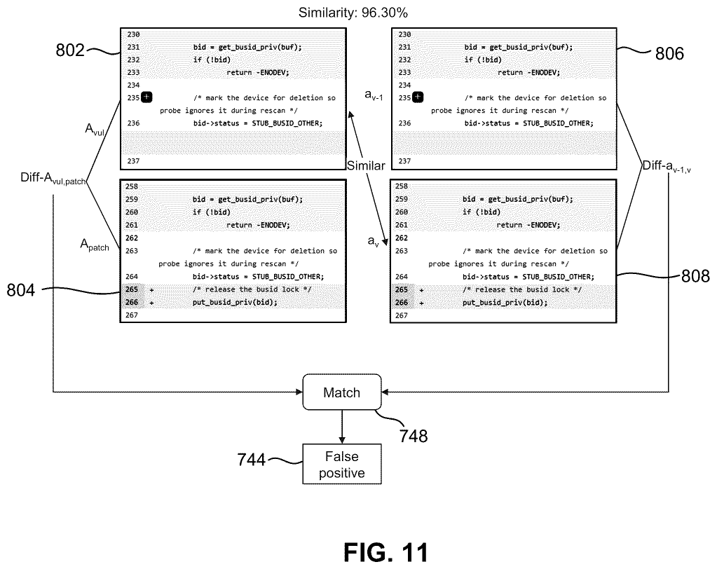

FIG. 11 shows an example of the detection of a false positive. FIG. 11 shows a vulnerable code section 802 and a patch for the vulnerability 804. FIG. 11 also shows a target section of computer code 808 and a historical version of the target section of computer code 806. Since the patch makes only a one line change to the computer code, the current version of the computer code 808 is over 96% similar to the vulnerability 802. The computer code 808 may therefore be detected as a potential vulnerability. However, since the patch has been applied to the computer code 808, the diff between the computer code 808 and the historical version of the computer code 806 may be similar to the diff between the vulnerability 802 and the patch 804. As such, according to the present disclosure, the section of computer code 808 may be filtered out as a false positive since it may not contain the vulnerability. The vulnerability has already been fixed in computer code 808.

The system and method disclosed in the present disclosure may be referred to as VulDiffFilter.

The Torvalds/Linux repository contains 28 known vulnerabilities (according to the Common Vulnerabilities and Exposures (CVE) Database). VulDiffFilter detected 53 potential similar vulnerabilities in openharmony/kernel_linux_5.10. After manual verification, security experts detected 4 similar vulnerabilities and 49 false positives. VulDiffFilter detected 11 potential vulnerabilities (including the 4 true positives), and it filtered 42 false positives. So in this test, recall of VulDiffFilter was 100%, and precision was 36%.

According to results of task id 1578701232321609730 in Nebula, 19 CVE ids were selected for evaluation. After manual verification, Nebula has 47 similar vulnerabilities, including 36 potential vulnerabilities and 11 false positives. VulDiffFilter detected 38 potential vulnerabilities (including the 36 true positives). Recall of VulDiffFilter was 100% and precision was 95%.

The performance of VulDiffFilter may be compared to the current state of the art (SOTA) in the following table:

TABLE 1
Performance comparison between VulDiffFilter and SOTA.

Precision

| Project | VulDiffFilter | SOTA |
|---|---|---|
| openharmony/kernel_linux_5.10 | 36% (4/11) | 8% (4/53) |
| Nebula (containing multiple repos) | 95% (36/38) | 77%(36/47) |

The method 600 may further comprise detecting rollback false positives. A rollback false positive may occur if a vulnerability has been patched but the patch is removed because the vulnerability has been fixed by another means. In this case, the section of computer code may be identical to the vulnerable section of computer code, even though the section of computer code does not contain the vulnerability. The method 600 may detect rollback false positives in the following manner. The method 600 may determine that the section of computer code (aᵥ) is identical to the known vulnerability (A). The method 600 may further determine that the second change (Diff-A_{vul,patch}) is the reverse of the first change (diff-a_{v-x,v}).

For example, the second change may comprise adding an if-statement, while the first change may comprise the removal of the same if-statement. The method 600 may thus determine that the section of computer code (aᵥ) comprises a rollback false positive.

Although embodiments have been described above with reference to the accompanying drawings, those of skill in the art will appreciate that variations and modifications may be made without departing from the scope thereof as defined by the appended claims.

1. A method for detecting vulnerabilities in computer code, comprising:
calculating a first change between a first version of a section of the computer code and a second version of the section of the computer code, the section of the computer code being similar to a computer-code vulnerability, and the second version is a version prior to the first version; and
determining whether the section of the computer code comprises the computer-code vulnerability based on a similarity between the first change and a second change, the second change being a change between the computer-code vulnerability and a fix for the computer-code vulnerability.

2. The method of claim 1 further comprising calculating the second change between the computer-code vulnerability and the fix for the computer-code vulnerability.

3. The method of claim 1, further comprising locating the section of the computer code that is similar to the computer-code vulnerability.

4. The method of claim 3, wherein locating the section of the computer code that is similar to the computer-code vulnerability comprises using code clone detection.

5. The method of claim 4, wherein the code clone detection uses artificial intelligence.

6. The method of claim 1, further comprising determining the similarity of the first change and the second change using code clone detection.

7. The method of claim 1, further comprising calculating a plurality of changes between the first version of the section of the computer code and a plurality of other versions of the section of the computer code, wherein the plurality of other versions are versions prior to the first version.

8. The method of claim 7, wherein determining whether the section of the computer code comprises the computer-code vulnerability is based on the similarity of the second change and any one of the plurality of changes.

9. The method of claim 1, wherein determining whether the section of the computer code comprises the computer-code vulnerability comprises determining that the section of the computer code does not comprise the computer-code vulnerability when the first change is similar to the second change.

10. The method of claim 1, wherein determining whether the section of the computer code comprises the computer-code vulnerability comprises determining that the section of the computer code comprises the computer-code vulnerability when the first change is not similar to the second change.

11. The method of claim 1, further comprising receiving the computer-code vulnerability from a security advisory service.

12. The method of claim 1, further comprising displaying the section of the computer code when the section of the computer code comprises the computer-code vulnerability.

13. A non-transitory computer-readable medium comprising computer instructions stored thereon for detecting vulnerabilities in computer code, wherein the computer instructions, when executed by one or more processors, causes the one or more processors to perform a method comprising:
calculating a first change between a first version of a section of the computer code and a second version of the section of the computer code, the section of the computer code being similar to a computer-code vulnerability, and the second version is a version prior to the first version; and
determining whether the section of the computer code comprises the computer-code vulnerability based on a similarity between the first change and a second change, the second change being a change between the computer-code vulnerability and a fix for the computer-code vulnerability.

14. The non-transitory computer-readable medium of claim 13, wherein the method further comprises calculating the second change between the computer-code vulnerability and the fix for the computer-code vulnerability.

15. The non-transitory computer-readable medium of claim 13, wherein the method further comprises locating the section of the computer code that is similar to the computer-code vulnerability.

16. The non-transitory computer-readable medium of claim 13, wherein the method further comprises calculating a plurality of changes between the first version of the section of the computer code and a plurality of other versions of the section of the computer code, wherein the plurality of other versions are versions prior to the first version.

17. A computing device comprising one or more processors operable to perform a method for detecting vulnerabilities in computer code, wherein the method comprises:
calculating a first change between a first version of a section of the computer code and a second version of the section of the computer code, the section of the computer code being similar to a computer-code vulnerability, and the second version is a version prior to the first version; and
determining whether the section of the computer code comprises the computer-code vulnerability based on a similarity between the first change and a second change, the second change being a change between the computer-code vulnerability and a fix for the computer-code vulnerability.

18. The computing device of claim 17, wherein the method further comprises calculating the second change between the computer-code vulnerability and the fix for the computer-code vulnerability.

19. The computing device of claim 17, wherein the method further comprises locating the section of the computer code that is similar to the computer-code vulnerability.

20. The computing device of claim 17, wherein the method further comprises calculating a plurality of changes between the first version of the section of the computer code and a plurality of other versions of the section of the computer code, wherein the plurality of other versions are versions prior to the first version.
